(19) United States
(12) Patent Application Publication
(10) Pub. No.: US 2001/0040943 A1
(43) Pub. Date: Nov. 15, 2001

(54) Telecommunication system, as well as switch, as well as terminal, as well as method

(76) Inventor: Joachim Endler, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/840,045

(22) Filed: Apr. 24, 2001

(30) Foreign Application Priority Data
May 15, 2000 (EP) 00 440 139.4

(51) Int. Cl. H04M 1/64; H04M 3/42

(52) U.S. Cl. 379/88.25; 379/201.01; 379/211.02

(57) ABSTRACT

The efficiency of telecommunication systems comprising a switch and a memory for storing messages originating from a first terminal and destined for a second terminal, can be increased by introducing a generator in said second terminal for generating a specific signal to be sent to said switch and defining a user of said second terminal being interested in a specific message mail, and by providing said switch with a detector for detecting said specific signal and with a processor for in response to said detecting ordering said memory to generate said specific message to be sent to said second terminal. By introducing a further generator in said first terminal for generating an indication signal to be sent to said switch and defining a message originating from a user of said first terminal being a specific message, the telecommunication system offers many user possibilities.

The invention relates to a telecommunication system comprising a switch and a memory for storing at least one message originating from a first terminal and destined for a second terminal.

Such a telecommunication system is known from for example U.S. Pat. No. 5,751,794—Proactive Voice Mail Service—in which a message for a customer is stored in a server in case of this customer not answering an incoming call or already being involved in an other call, after which a status of the line is frequently tested to be able to deliver said message.

Such a telecommunication system is disadvantageous, inter alia, due to said frequently testing making it inefficient.

It is an object of the invention, inter alia, to provide a telecommunication system as described in the preamble, which is more efficient.

Thereto, the telecommunication system according to the invention is characterised in that said second terminal comprises a generator for generating a specific signal to be sent to said switch and defining a user of said second terminal being interested in at least one specific message, with said switch comprising a detector for detecting said specific signal and comprising a processor for in response to said detecting ordering said memory to generate said at least one specific message to be sent to said second terminal.

By introducing said specific signal, the switch is informed of said user of said second terminal being interested in a specific message, and as a result said specific message is sent to said user.

The invention is based on the insight, inter alia, that frequently testing can be avoided by detecting a user action and/or a user presence.

The invention solves the problem, inter alia, of increasing the efficiency of known telecommunication systems by avoiding said frequently testing.

A first embodiment of the telecommunication system according to the invention is characterised in that said specific signal comprises a destination signal defining a destination of said first terminal and/or comprises a predefined specific code.

In case of said specific signal comprising said destination signal defining a destination of said first terminal (for example a (part of a) telephone number of said first terminal and/or an identification of said user of said first terminal due to said user of said second terminal being interested in a specific message from (said user of) this specific first terminal or for example said telephone number of said first terminal due to said user of said second terminal needing to make a call with said user of said first terminal), and/or in case of said specific signal comprising said predefined specific code (for example #00# etc.), said specific signal comprises detailed info allowing the system to react more specifically.

A second embodiment of the telecommunication system according to the invention is characterised in that said first terminal comprises a further generator for generating an indication signal to be sent to said switch and defining at least one message originating from a user of said first terminal being a specific message, with said switch comprising a further detector for detecting said indication signal.

By introducing said indication signal, the switch is informed of said user of said first terminal generating a specific message. Such an indication signal allows said user of said first terminal for example to choose whether a message should be regarded to be specific or not.

A third embodiment of the telecommunication system according to the invention is characterised in that said indication signal comprises a destination signal defining a destination of said second terminal and/or comprises a predefined indication code.

In case of said indication signal comprising said destination signal defining a destination of said second terminal (for example a (part of a) telephone number of said second terminal and/or an identification of said user of said second terminal due to said user of said first terminal being interested in reaching (said user of) this indicated second terminal or for example said telephone number of said second terminal due to said user of said first terminal needing to make a call with said user of said second terminal), and/or in case of said indication signal comprising said predefined indication code (for example #99# etc.), said indication signal comprises detailed info allowing the system to react as indicated precisely.

The invention further relates to a switch for use in a telecommunication system comprising said switch and a memory for storing at least one message originating from a first terminal and destined for a second terminal.

The switch according to the invention is characterised in that said switch comprises a detector for detecting a specific signal originating from said second terminal and defining a user of said second terminal being interested in at least one specific message, and comprises a processor for in response to said detecting ordering said memory to generate said at least one specific message to be sent to said second terminal.

A first embodiment of the switch according to the invention is characterised in that that said specific signal comprises a destination signal defining a destination of said first terminal and/or comprises a predefined specific code.

A second embodiment of the switch according to the invention is characterised in that said switch comprises a further detector for detecting an indication signal originating from said first terminal and defining at least one message originating from a user of said first terminal being a specific message.

A third embodiment of the switch according to the invention is characterised in that said indication signal comprises a destination signal defining a destination of said second terminal and/or comprises a predefined indication code.

The invention yet further relates to a terminal for use in a telecommunication system comprising a switch and a memory for storing at least one message destined for said terminal and originating from an other terminal.

The terminal according to the invention is characterised in that said terminal comprises a generator for generating a specific signal to be sent to said switch and defining a user of said terminal being interested in at least one specific message, with said switch comprising a detector for detecting said specific signal and comprising a processor for in response to said detecting ordering said memory to generate said at least one specific message to be sent to said terminal.

Embodiments of the terminal according to the invention are characterised in that said specific signal comprises a destination signal defining a destination of said other terminal and/or comprises a predefined specific code, and/or in that said terminal comprises a further generator for generating an indication signal to be sent to said switch and defining at least one message originating from a user of said terminal being a specific message, with said switch comprising a further detector for detecting said indication signal, and/or in that said indication signal comprises a destination signal defining a destination of said other terminal and/or comprises a predefined indication code.

The invention also relates to a method for use in a telecommunication system comprising a switch and a memory for storing at least one message originating from a first terminal and destined for a second terminal.

The method according to the invention is characterised in that said method comprises the steps of generating a specific signal to be sent from said second terminal to said switch and defining a user of said second terminal being interested in at least one specific message, and detecting said specific signal and in response to said detecting ordering said memory to generate said at least one specific message to be sent to said second terminal, and sending said at least one specific message to said second terminal.

Embodiments of the method according to the invention are characterised in that said method comprises the steps of said specific signal comprising a destination signal defining a destination of said first terminal and/or comprising a predefined specific code, and/or of generating an indication signal to be sent to said switch and defining at least one message originating from a user of said first terminal being a specific message and of detecting said indication signal, and/or of said indication signal comprising a destination signal defining a destination of said second terminal and/or comprising a predefined indication code.

The document U.S. Pat. No. 5,751,794 discloses a proactive voice mail service which is completely different from the telecommunication system according to the invention, which invention solves the problem as defined at the hand of said document. All references including further references cited with respect to and/or inside said references are considered to be incorporated in this patent application.

The invention will be further explained at the hand of embodiments described with respect to a drawing, whereby

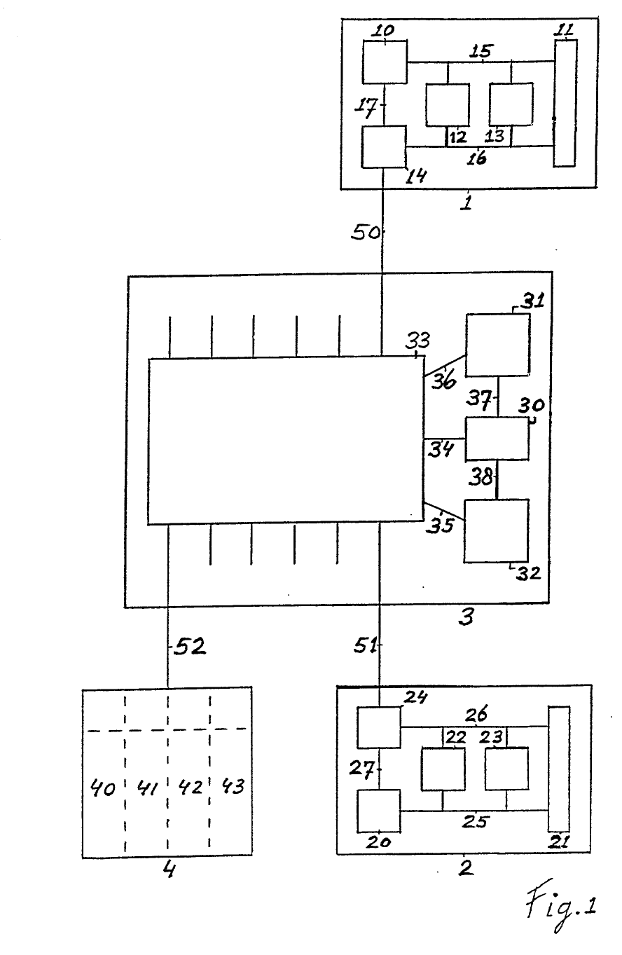

FIG. 1 discloses a telecommunication system according to the invention comprising a switch according to the invention and terminals according to the invention.

In FIG. 1, a first terminal 1 according to the invention comprises a processor 10 coupled via a control bus 15 to a man-machine-interface (mmi) 11 and to a generator 12 and to a memory 13. Processor 10 is coupled via a control connection 17 to a transceiver 14, which via a bus 16 is coupled to said mmi 11 and to said generator 12 and to said memory 13. Transceiver 17 is further coupled via a connection 50 to switch 3. A second terminal 2 according to the invention comprises a processor 20 coupled via a control bus 25 to a man-machine-interface (mmi) 21 and to a generator 22 and to a memory 23. Processor 20 is coupled via a control connection 27 to a transceiver 24, which via a bus 26 is coupled to said mmi 21 and to said generator 22 and to said memory 23. Transceiver 27 is further coupled via a connection 51 to switch 3. Switch 3 comprises a coupler 33 coupled to connection 50 and 51 and via a connection 52 to a memory 4 comprising at least four parts 41-44. Coupler 33 in switch 3 is coupled to a processor 30 via a control connection 34 and to a memory 31 via a control connection 36 and to a detector 32 via a control connection 35, whereby processor 30 is coupled to memory 31 via a control connection 37 and to detector 32 via a control connection 38.

The telecommunication system according to the invention comprising terminals 1,2 according to the invention and switch 3 according to the invention functions as follows.

According to a first embodiment, a first user of terminal 1 decides to call a second user of terminal 2. Thereto, said first user enters a telephone number of said terminal 2 at mmi 11. Via control bus 15, processor 10 is informed, which controls mmi 11 via control bus 15 and transceiver 14 via control connection 17 in such a way that said telephone number via bus 16 and generator 12 (possibly in cooperation with memory 13) and transceiver 14 and connection 50 is sent to switch 3 in the form of a signalling signal (being an indication signal comprising a destination signal defining a destination of said terminal 2). In switch 3, said telephone number is supplied via coupler 33 and control connection 34 to processor 30, which in response consults memory 31 and/or detector 32 to verfiy whether said second user of terminal 2 can be reached at terminal 2 or not (due to for example a follow-me function being activated or due to for example terminal 2 being busy) and whether said second user of terminal 2 should be reached or not (due to for example said second user having left a message in memory 4), and in case of said second user being reachable at terminal 2, processor 30 tries to set up a speech connection between terminal 1 and terminal 2 and starts a timer function.

Due to for example either said terminal 2 being busy or not having answered said call within a time interval defined by said timer function, processor 30 will decide to set up a speech connection between terminal 1 and memory 4 (like for example a voice mail system) via connection 50 and coupler 33 and connection 52, in response to which said first user of terminal 1 receives a spoken message informing him that he has been connected to said memory and that he could leave his message behind after the beep.

After some time, said second user decides to call said first user, and enters the telephone number of said terminal 1 at mmi 21. Via control bus 25, processor 20 is informed, which controls mmi 21 via control bus 25 and transceiver 24 via control connection 27 in such a way that said telephone number via bus 26 and generator 22 (possibly in cooperation with memory 23) and transceiver 24 and connection 51 is sent to switch 3 in the form of a signalling signal (being a specific signal comprising a destination signal defining a destination of said terminal 1). In switch 3, said telephone number is supplied via coupler 33 and control connection 34 to processor 30, which in response consults memory 31 and/or detector 32 to verify whether said first user of terminal 1 can be reached at terminal 1 or not (due to for example a follow-me function being activated or due to for example terminal 1 being busy) and whether said first user of terminal 1 should be reached or not (due to for example said first user having left a message in memory 4). This time, processor 30 finds out that said first user of terminal 1 has left a message for said second user in memory 4 (which message is stored in memory 4 at an address, which address for example is stored in memory 31 in combination with said telephone number of said first terminal and/or of said second terminal), and as a result a speech connection is set up between terminal 2 and memory 4 via connection 51 and coupler 33 and connection 52, in response to which said second user of terminal 2 receives said stored message as left behind by said first user. So, according to the invention, in response to said specific signal (the telephone number of said first user who has left a message in the voice mail system), said second user is automatically connected to said voice mail system for getting said specific message (non-specific messages can for example be got by dialling the number of said voice mail system).

According to a first alternative to said first embodiment, a first user of terminal 1 decides to call a second user of terminal 2, and as described before, said first user of terminal 1 receives said spoken message informing him that he has been connected to said memory and that he could leave his message behind after the beep.

After some time, said second user decides to check his mail box, whereby he is interested in specific messages only originating from said first user. Thereto, he enters a predefined specific code (for example #00#) at mmi 21. Via control bus 25, processor 20 is informed, which controls mmi 21 via control bus 25 and transceiver 24 via control connection 27 in such a way that said predefined specific code via bus 26 and generator 22 (possibly in cooperation with memory 23) and transceiver 24 and connection 51 is sent to switch 3 in the form of a signalling signal (being a specific signal comprising said predefined specific code). In switch 3, said predefined specific code is supplied via coupler 33 and control connection 34 to processor 30, which in response consults memory 31 and/or detector 32. Processor 30 finds out that said first user of terminal 1 has left a message for said second user in memory 4 (which message is stored in memory 4 at an address, which address for example is stored in memory 31 in combination with said telephone number of said first terminal and/or of said second terminal and/or with said predefined specific code), and as a result a speech connection is set up between terminal 2 and memory 4 via connection 51 and coupler 33 and connection 52, in response to which said second user of terminal 2 receives said stored message as left behind by said first user. So, according to the invention, in response to said specific signal (the predefined specific code), said second user is automatically connected to said voice mail system for getting said specific message only (non-specific messages and/or all messages can for example be got by dialling the number of said voice mail system).

According to a second alternative to said first embodiment, a first user of terminal 1 decides to call a second user of terminal 2, and as described before, said first user of terminal 1 receives said spoken message informing him that he has been connected to said memory and that he could leave his message behind after the beep.

After some time, said second user decides to call said first user, and enters the telephone number of said terminal 1 at mmi 21, together with a predefined specific code (for example #00#), which predefined specific code defines that he is interested in specific messages only originating from said first user. Via control bus 25, processor 20 is informed, which controls mmi 21 via control bus 25 and transceiver 24 via control connection 27 in such a way that said telephone number together with said predefined specific code via bus 26 and generator 22 (possibly in cooperation with memory 23) and transceiver 24 and connection 51 is sent to switch 3 in the form of a signalling signal (being a specific signal comprising a destination signal defining a destination of said terminal 1 as well as said predefined specific code). In switch 3, said telephone number and predefined specific code are supplied via coupler 33 and control connection 34 to processor 30, which in response consults memory 31 and/or detector 32 to verfiy whether said first user of terminal 1 can be reached at terminal 1 or not (due to for example a follow-me function being activated or due to for example terminal 1 being busy) and whether said first user of terminal 1 should be reached or not (due to for example said first user having left a message in memory 4). This time, processor 30 finds out that said first user of terminal 1 has left a message for said second user in memory 4 (which message is stored in memory 4 at an address, which address for example is stored in memory 31 in combination with said telephone number of said first terminal and/or of said second terminal and/or with said predefined specific code), and as a result a speech connection is set up between terminal 2 and memory 4 via connection 51 and coupler 33 and connection 52, in response to which said second user of terminal 2 receives said stored message as left behind by said first user. So, according to the invention, in response to said specific signal (the telephone number of said first user who has left a message in the voice mail system together with said predefined specific code), said second user is automatically connected to said voice mail system for getting said specific message (nonspecific messages can for example be got by dialling the number of said voice mail system).

According to a third alternative to said first embodiment, a first user of terminal 1 decides to leave a specific message behind in memory 4 for a second user of terminal 2. Thereto, said first user enters a predefined indication code (for example #99#) at mmi 11. Via control bus 15, processor 10 is informed, which controls mmi 11 via control bus 15 and transceiver 14 via control connection 17 in such a way that said predefined indication code via bus 16 and generator 12 (possibly in cooperation with memory 13) and transceiver 14 and connection 50 is sent to switch 3 in the form of a signalling signal (being an indication signal comprising said predefined indication code). In switch 3, said predefined indication code is supplied via coupler 33 and control connection 34 to processor 30, which in response consults memory 31 and/or detector 32. Processor 30 then decides to set up a speech connection between terminal 1 and memory 4 (like for example a voice mail system) via connection 50 and coupler 33 and connection 52, in response to which said first user of terminal 1 receives a spoken message informing him that he has been connected to said memory and that he could leave his message behind after the beep.

After some time, said second user decides to call said first user, and enters the telephone number of said terminal 1 at mmi 21, or said second user decides to check his mail box, whereby he is interested in specific messages only originating from said first user, or said second user decides to call said first user, and enters the telephone number of said terminal 1 at mmi 21, together with a predefined specific code (for example #00#), which predefined specific code defines that he is interested in specific messages only originating from said first user, etc. as described before.

According to a fourth alternative to said first embodiment, a first user of terminal 1 decides to call a second user of terminal 2. Thereto, said first user enters a telephone number of said terminal 2 at mmi 11, together with a predefined indication code (for example #99#), which predefined indication code defines that he is interested in leaving behind a specific message in memory 4 destined for said second user, in case said second user cannot be reached, etc. as described before.

According to a fifth alternative to said first embodiment, a first user of terminal 1 decides to call a second user of terminal 2, and as described before, said first user of terminal 1 receives said spoken message informing him that he has been connected to said memory and that he could leave his message behind after the beep. This time, said first user has the option of leaving behind a specific message (by entering the predefined indication code) or not, etc.

According to a second embodiment, a first user of terminal 1 directly contacts memory 4 by entering a telephone number of this voice mail system, with a destination signal defining a destination of a second user of terminal 2 being added to this telephone number or being added to the message to be entered, etc.

According to a first alternative to said second embodiment, said first user not just enters said telephone number, but also enters a predefined indication code, with a destination signal defining a destination of a second user of terminal 2 being added to this telephone number and/or predefined indication code or being added to the message to be entered, etc.

According to a second alternative to said second embodiment, said first user just enters said predefined indication code, with a destination signal defining a destination of a second user of terminal 2 being added to this predefined indication code or being added to the message to be entered, etc.

According to a third alternative to said second embodiment, said first user enters said predefined indication code after said speech connection has been established just before or together with his message, etc.

According to a third embodiment, switch 3 (read: detector 32) detects a telephone number of terminal 1 and/or a predefined indication code and/or a telephone number of terminal 2 and in dependence connects or tries to connect terminal 1 with either terminal 2 or memory 4 and in dependence defines messages to be specific or non-specific, etc.

All embodiments are just embodiments and do not exclude other embodiments not shown and/or described. All alternatives are just alternatives and do not exclude other alternatives not shown and/or described. Any part of (any alternative to) any embodiment can be combined with any other part of (any alternative to) any embodiment, without departing from the scope of this invention.

Said connections 50, 51 and 52 can be analog connections, digital connections, ISDN connections, wireless (for example) DECT connections, mobile (for example GSM, UMTS) connections, and/or may form part of so-called always-on-IP-connections (to be created by for example using xDSL, ISDN, GPRS etc., see for example EP-99440311.1). Said switch 3 located between both terminals 1 and 2 is not necessarily the only switch between both terminals, generally there can be more than one switch, and/or said switch could comprise several subsystems like in an Intelligent Network or IN environment where there are SSPs (Service Switching Points) and SCPs (Service Control Points), in which case coupler 33 for example forms part of a SSP and processor 30 forms part of a SCP. A Universal Personal Telephony system or UPT is not to be excluded, wereby said (fixed/wireless/mobile) terminals will be provided with a temporarily telephone number in dependence of (an identification of) a user. These temporarily telephone numbers will generally be stored in (memory 31 of) switch 3.

Said generators and detectors are either hardware components or software components or mixtures of both. (Parts of) Functions of terminals 1,2 can be shifted into switch 3, and vice versa. (Parts of) Functions of switch 3 can be shifted into memory 4, and vice versa. The addressing of memory 4 can be organised in switch 3, as described, but could also be managed in memory 4. Memory 4 comprises four parts 40-43, for example four columns, with a column 40 being destined for an address of a message, column 41 being destined for telephone numbers defining an origin of a message, column 42 deing destined for telephone numbers defining a destination of a message, and column 43 being destined for said message. But many more columns (in general parts) are possible, for example for storing a message being a specific one or not. Further, in view of said possibly shifting of functions from switch 3 into memory 4 and vice versa, it should be noted that memories 4 and 31 could be more or less integrated and then located either inside switch 3 or outside, etc.

The term ‘message’ should not be limited to ‘voice message’, but may include other kinds of messages like data, email, video etc. In case of said terminals being screenphones (like defined in EP-90727X with X=1, 2, 3, 4, 5), a user could leave behind a video message. Or, in view of the Internet being used more and more often, a user could leave behind an email, or a data signal defining that an email has been sent, or an address of a website, whereby this information either is shown on (a display of) the receiving terminal or is converted into speech, etc. In view of this, said specific signal and/or said indication signal may also define the kind of message, in other words whether said specific message is a video message or email message or data message etc.

1. Telecommunication system comprising a switch and a memory for storing at least one message originating from a first terminal and destined for a second terminal, characterised in that said second terminal comprises a generator for generating a specific signal to be sent to said switch and defining a user of said second terminal being interested in at least one specific message, with said switch comprising a detector for detecting said specific signal and comprising a processor for in response to said detecting ordering said memory to generate said at least one specific message to be sent to said second terminal.

2. Telecommunication system according to claim 1, characterised in that said specific signal comprises a destination signal defining a destination of said first terminal and/or comprises a predefined specific code.

3. Telecommunication system according to claim 1 or 2, characterised in that said first terminal comprises a further generator for generating an indication signal to be sent to said switch and defining at least one message originating from a user of said first terminal being a specific message, with said switch comprising a further detector for detecting said indication signal.

4. Telecommunication system according to claim 3, characterised in that said indication signal comprises a destination signal defining a destination of said second terminal and/or comprises a predefined indication code.

5. Switch for use in a telecommunication comprising said switch and a memory for storing at least one message originating from a first terminal and destined for a second terminal, characterised in that said switch comprises a detector for detecting a specific signal originating from said second terminal and defining a user of said second terminal being interested in at least one specific message, and comprises a processor for in response to said detecting ordering said memory to generate said at least one specific message to be sent to said second terminal.

6. Switch according to claim 5, characterised in that said specific signal comprises a destination signal defining a destination of said first terminal and/or comprises a predefined specific code.

7. Switch according to claim 5 or 6, characterised in that said switch comprises a further detector for detecting an indication signal originating from said first terminal and defining at least one message originating from a user of said first terminal being a specific message.

8. Switch according to claim 7, characterised in that said indication signal comprises a destination signal defining a destination of said second terminal and/or comprises a predefined indication code.

9. Terminal for use in a telecommunication system comprising a switch and a memory for storing at least one message destined for said terminal and originating from an other terminal, characterised in that said terminal comprises a generator for generating a specific signal to be sent to said switch and defining a user of said terminal being interested in at least one specific message, with said switch comprising a detector for detecting said specific signal and comprising a processor for in response to said detecting ordering said memory to generate said at least one specific message to be sent to said terminal.

10. Method for use in a telecommunication system comprising a switch and a memory for storing at least one message originating from a first terminal and destined for a second terminal, characterised in that said method comprises the steps of generating a specific signal to be sent from said second terminal to said switch and defining a user of said second terminal being interested in at least one specific message, and detecting said specific signal and in response to said detecting ordering said memory to generate said at least one specific message to be sent to said second terminal, and sending said at least one specific message to said second terminal.
